(19) United States
(12) Patent Application Publication
(10) Pub. No.: US 2007/0094506 A1
(43) Pub. Date: Apr. 26, 2007

(54) Method for distributing and clearing digital contents via on-line

(76) Inventor: Min Wook Kim, Seoul (KR)

Correspondence Address: CANTOR COLBURN, LLP, 55 GRIFFIN ROAD SOUTH, BLOOMFIELD, CT, 06002, US

(21) Appl. No.: 11/246,744

(22) Filed: Oct. 7, 2005

(51) Int. Cl. H04L 9/00

(52) U.S. Cl. 713/176

(57) ABSTRACT

Disclosed is a method for distributing and clearing digital contents via on-line which is performed by a system for distributing and clearing digital contents via on-line that includes Internet, systems of users who are consumers and distributors of digital contents through the Internet and a main system having a database for storing a list of the digital contents. The user system downloads and installs a dedicated program having a function of watermarking the digital contents and a function of executing the watermarked digital contents. The user system searches the systems of other users if the user system intends to purchase or download the digital contents, and the dedicated program performs watermarking of the digital contents when the digital contents are downloaded to the user system. A settled amount through a settlement system according to the purchase of the digital contents is distributed to a rightful owner of the digital contents and a user who has distributed the digital contents in the predetermined ratio.

### TECHNICAL FIELD

The present invention relates to a method for distributing and clearing digital contents via on-line, and more particularly to a method for distributing and clearing digital contents via on-line that can protect author's rights and interests with respect to digital contents distributed through peer-to-peer (P2P) networks.

In particular, the present invention relates to a method for distributing digital contents via on-line and a clearing method for the same which intercepts an illegal distribution of all types of digital contents such as music files, moving image files, still image files, and others via on-line, and makes proper charges be paid for the digital contents being distributed. In addition, the present invention relates to a method for distributing digital contents via on-line and a clearing method for the same which maximizes contents providers' profits through consumers' voluntary distribution of the digital contents.

### BACKGROUND ART

Nowadays, with the abrupt spread of the Internet, Internet users can promptly search for desired data at home. In particular, due to the abrupt spread of the high-speed Internet, the users can download music files and moving image files such as movies in a short time and delight in music and movie enjoyment, which cannot be expected with low-speed Internets.

Recently, the distribution of a digital contents file such as a music file or a moving image file through the high-speed Internet may be illegally performed without paying charges in a manner that a file accidentally searched by an Internet user during his/her Internet surfing or a moving image file or a music file is converted into a proper form for the purpose of distributing the file on the Internet, that is, the moving image file such as a movie is converted into a form of MPEG, EMV, and others and the music file is converted into a form of MP3, WMA, asf, and others, and then the converted file is uploaded through the Internet. Due to such illegal on-line digital content distribution, copyright holders and production agencies having produced movie and music files by investing heavily in the files have been suffering great loss. Although movie or music production agencies have exerted their great efforts to prevent the illegal distribution of the digital contents, it is originally difficult to intercept the illegal distribution of the digital contents files since most illegal distributions of the digital contents files are individually performed, it takes too much time to search and control enormous illegal web sites, and illegal web sites come into existence and disappear at all times. In particular, although the illegal distribution of files using a P2P system such as Napster has presently been judged as illegal and prohibited, it is still illegal. In addition, although some P2P sites have been judged as illegal and the use thereof has been prohibited, a system that connects users without placing any dedicated server, which is completely different from the existing P2P system, is now under service. This would be also legally criticizable, and if it is judged as not illegal, it would be clear that rightful owners or the production agencies suffer a loss. Accordingly, if there is a system that imposes proper charges on the multimedia distribution which may be illegal, it would be a great help for the wholesome multimedia distribution.

Currently, most production agencies are producing and distributing movie or music files in the form of a video tape, a cassette tape or a CD, and are advertising them for their sale at a great cost. However, since the Internet speed has become faster and users who are familiar with the Internet intend to obtain all things through the Internet, it will be apparent that the distribution of movie or music files through the Internet has greatly increased along with the continuous distribution of them through off-line. Accordingly, it is required to achieve a safe distribution through the Internet, and it is judged that with the consumers' voluntary distribution and advertisement of the digital files through the Internet, copyright holders and production agencies will greatly profit in money and time.

### DISCLOSURE OF THE INVENTION

Therefore, the present invention has been made in view of the above-mentioned problems, and it is an object of the present invention to intercept an illegal distribution of files and to make proper charges be paid for the files being distributed in distributing data through the Internet and particularly in distributing multimedia files through P2P, so that copyright holders and production agencies of the multimedia files suffer no loss.

It is another object of the present invention to achieve a smooth supply and distribution of multimedia files without letting copyright holders and production agencies of the multimedia files defray the expenses for the advertisement and distribution of the files by making specified profits be given to private users, who are consumers and retailers of the multimedia files, connected through B2C or P2P networks in distributing the multimedia files through the B2C or P2P, and making the advertisement and distribution of the multimedia files be performed through the users who are the consumers and retailers.

In order to achieve the above objects, in one aspect of the present invention, there is provided a method for distributing and clearing digital contents via on-line which is performed by a system for distributing and clearing digital contents via on-line that includes Internet, systems of users who are consumers and distributors of digital contents through the Internet and a main system having a database for storing a list of the digital contents.

The method for distributing and clearing digital contents via on-line according to the present invention includes (a) the user system downloading and installing a dedicated program having a function of watermarking the digital contents and a function of executing the watermarked digital contents, (b) the user system searching the systems of other users if the user system intends to purchase or download the digital contents, and (c) the dedicated program installed in the user system performing watermarking of the downloaded digital contents when the digital contents are downloaded to the user system.

The digital contents are compulsorily watermarked when the peer-to-peer (P2P) type download of the digital contents is performed, and the watermarked digital contents are executable only by the dedicated program. Accordingly, the execution of the dedicated program may be restricted to be performed only on a specified condition (for example, on condition that charges for the use of the digital contents have been paid) although the download of the digital contents may be performed unrestrictedly, or the download of the digital contents may be restricted to be performed only on the specified condition as described above.

In step (c), the dedicated program confirms whether the downloaded digital contents are watermarked by the dedicated program, and if the digital contents are not watermarked, it watermarks the downloaded digital contents.

In step (b), the user system searches the systems of other users through the main system. When the user system distributes or sells the digital contents, it provides information about the digital contents stored in the system to the main system, so that the main system stores the information in the database. As the information about the digital contents selected to be purchased or downloaded by the user is transmitted from the user system to the main system, the main system downloads the digital contents that coincide with items pre-stored in the digital contents list database to the user system.

As described above, the main system can manage permission to use or distribute the digital contents. In step (d), when the main system writes the information about the digital contents in the database, it filters the file name of the digital contents by specified items and writes the filtered file name of the digital contents in the database. If the digital contents refer to music, the specified items include one or more of the title of music, a singer, a composer, a songwriter and a production agency, while if the digital contents refer to movie, the specified items include one or more of the title of a movie, a leading actor (or actress) and a production agency.

If the charges for the digital contents have been paid through a settlement system, an account settlement server distributes the settled amount to a rightful owner of the digital contents and a user who has distributed the digital contents in a predetermined ratio.

Since only the digital contents for which the charges have been paid can be downloaded by the dedicated program or can be executed after being downloaded, the rights and interests of the author can be protected. In another aspect of the present invention, there is provided a computer-readable recording medium recorded with a program having a function of compulsorily watermarking digital contents transmitted from a computer of another user through P2P, and a function of executing the watermarked digital contents. The program may further include a function of confirming whether the downloaded digital contents have been watermarked by the program, and a function of watermarking the downloaded digital contents if the digital contents have not been watermarked.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a view illustrating a system for distributing and clearing digital contents via on-line according to the present invention; and

FIG. 2 is a flowchart illustrating a method for distributing and clearing digital contents via on-line that is performed by the system of FIG. 1.

### BEST MODE FOR CARRYING OUT THE INVENTION

Reference will now be made in detail to the preferred embodiments of the present invention.

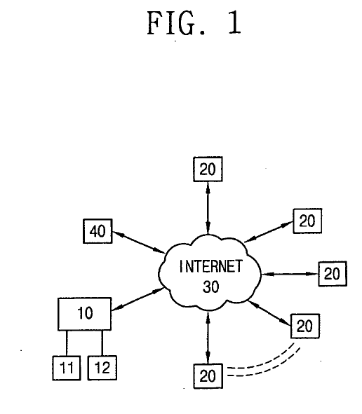

FIG. 1 is a view schematically illustrating a system for distributing and clearing digital contents via on-line according to the present invention.

As illustrated in FIG. 1, the system according to the present invention includes a main system 10, a settlement server 40 and user systems 20, in a similar manner to the existing B2C and P2P systems.

The main system 10 includes a digital contents list database 11 for storing information about detailed items for files that are exchanged among users, i.e. distributed files, and an account settlement server 12 for settling charges for the files distributed by the users. The main system filters the name of the file distributed by the users by specified items. The user system, which is typically composed of a computer, is a system that distributes the digital contents by transmitting/receiving the digital contents in a P2P method through the Internet 30.

The settlement server 40 is a system provided in a bank, a credit card company, and others, for settlement of the charges for distributing the digital contents via on-line.

Although the system for performing the method for distributing and clearing digital contents via on-line according to the present invention has a similar construction to the existing system, the digital contents list database 11 and the account settlement server 12 of the main system 10 and the dedicated program installed in the user system are different from those of the existing system. In particular, the dedicated program has a watermarking function. If a file which is downloaded from another user exists in the list of the digital contents list database, the dedicated program watermarks the file, so that the file is legally distributed and an illegal copy of the file through another distribution system is prevented.

In order to use the present invention, a user first becomes a member of the main system 10, downloads the dedicated program having the watermarking function, which is required to embody the present invention, from the main system 10, and then installs the downloaded dedicated program in the user's own system 20. As described above, in the case where the user downloads a file from another user's system through the main system, the dedicated program compulsorily performs a watermarking work so as to make a legal distribution of the file possible and to prevent an illegal copy of the file through another system.

If the user intends to distribute specified digital contents file (for example, music or moving image file) after the installation of the dedicated program is completed, he/she may attach a file name that indicates information about the digital contents to the digital contents and then store the digital contents with the file name attached thereto in a storage device of his/her own system. Then, other users may access the storage device and download the stored file.

Specifically, if another user who intends to download the file selects the desired file name, the main system 10 filters the file name of the digital contents by detailed items, for example, the title of music, the name of a singer, and others if the file is a music file, and compares the filtered items with information items of the file, for example, the title of music, the name of a singer, a copyright holder, whether the file has been distributed, and others, stored in the digital contents list database. If the title of music and the name of the singer are the same and the distribution of the file is permitted as a result of comparison, the download of the file is performed. In this case, the dedicated program of the user system judges whether the watermark for a legal distribution of the digital file and an interception of an illegal copy of the digital file is marked on a header of the digital file, and if there is no watermark on the header of the digital file, a watermarking work is performed. Through this watermarking work, the downloaded file can be used only in the system in which the dedicated program is installed. Accordingly, an illegal distribution of the digital file is naturally intercepted.

If a user searches another user's system and intends to purchase (or download) a file even in a state that users provide file names (i.e. file information) optionally registered through a site such as the existing Napster as they are, the main system 10 judges whether the file exists in the database and whether the file can be distributed by classifying the file name (i.e. file information) into specified detailed items, arranging the detailed items (i.e. filters the file name), and then comparing the detailed items with those pre-stored in the digital contents list database 11. If it is judged that the file exists in the database and its distribution is possible, the main system enables the users to download the file.

For example, even if the users incoherently register a new piece “Friend” of a singer “AAA” with several file names such as [AAA-Friend.mp3, AAA_Friend.mp3, FriendAAAmp3, FriendAAA_mp3] in their own systems and intend to distribute the file, the main system 10 classifies the file name into the title of music “Friend” and the name of the singer “AAA”, and compares the classified items with the items classified and stored in the database 11 to search a following record.

| | | | Song- | Production | | |
|---|---|---|---|---|---|---|
| Title | Singer | Composer | writer | Agency | Distribution | Price |
| Friend | AAA | XXX | YYY | ZZZ | Yes | $1.00 |

If it is judged that the record exists in the database 11, the main system 10 judges whether the distribution of the file has been permitted by a rightful owner. Since the music file “Friend” of a singer “AAA” exists and its distribution has been permitted, the user can download the file with payment of the charges. If the file refers to a movie, information such as [the title of a movie, a leading actor (or actress), a production agency, distribution, price] is stored in the database. If a watermark exists in the digital contents file that is distributed among users, the main system confirms the watermark, and compares items corresponding to the watermark with contents items in the database. If the file exits in the database as a result of comparison, the user can download the file through the above-described process.

If the user has paid the charges for the file through the settlement server 40 and the account settlement server 12 has received a settlement completion report from the settlement server 40, the account settlement server distributes the settled amount between the rightful owner (i.e. copyright holder or production agency) of the file and the user who has distributed the file in the predetermined ratio. For example, if the settled amount is $1.00, the account settlement server serves to pay $0.70 to the rightful owner and pay $0.30 to the user who has distributed the file. In other words, $0.70 is paid to the rightful owner, such as the copyright holder or the production agency, of the distributed literary work (in the present invention, the digital contents such as a music file, a moving image file, and others), and $0.30 is paid to the user as a cost for the digital contents distribution. As described above, if the users store a file (i.e. digital contents) to be distributed with the file name attached thereto in their own systems, and another user's system searches for a desired file after a dedicated program having a watermarking function for achieving a legal use of the file and for prevention of illegal use of the file is installed in the user systems, the main system classifies the file names (information) incoherently inputted by the user into specified items, and compares the classified items with the items pre-stored in the database 11 to perform the distribution.

Then, the user downloads the file with payment of the charges. When the user downloads the file, the dedicated program confirms whether a watermark for achieving the legal use of the file and for prevention of illegal use of the file exists in the file, and if the watermark does not exist in the file, it performs the watermarking. This watermark can be recognized only by the dedicated program installed in the user system that downloads the file, and thus the file execution is possible only through the system in which the dedicated program is installed. The account settlement server 12 distributes the amount calculated by the account settlement server to the rightful owner such as the production agency or the copyright holder and the file registrant (distributor) in the specified ratio. Accordingly, the illegal use of the file can be prevented by using the dedicated program. Also, irrespective of whether the user stores in the system and distributes a refined file or an illegal file wandering on the Internet, the downloaded file is always in a watermarked state and the download of the file always requires the payment of the charges, so that the illegal copy and distribution of the file can be originally intercepted. In addition, since the users can profit by distributing the file, they actively make their efforts to distribute the file, resulting in that the file producer or the copyright holder easily sell or advertise the file.

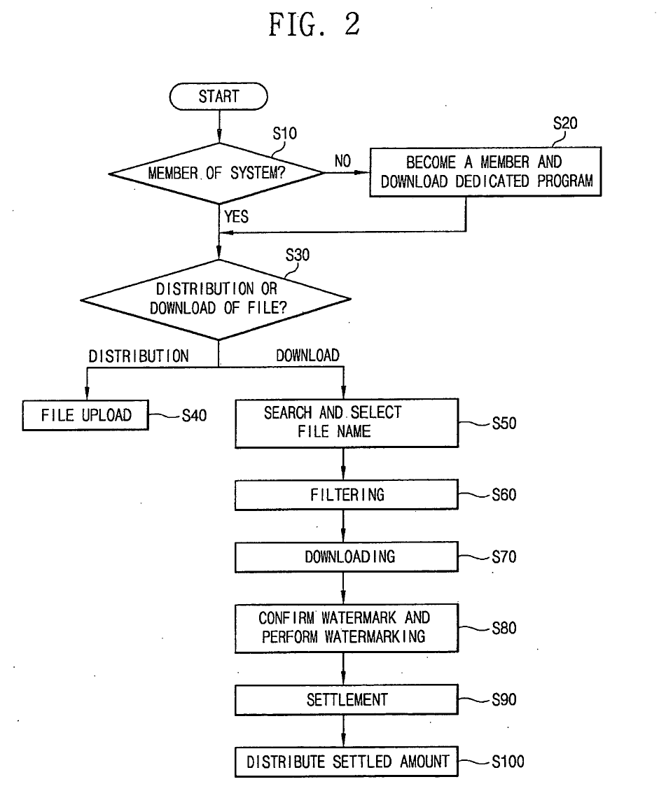

FIG. 2 is a flowchart illustrating a method for distributing and clearing digital contents via on-line that is performed by the system of FIG. 1.

First, a user accesses the main system 10 that performs an on-line distribution and clearing of digital contents (S10). If the user is a new member, he/she downloads and installs a dedicated program having a watermarking function to achieve a legal distribution of the digital contents and to prevent an illegal distribution of the digital contents in the user's system 20 (S20).

Then, the user selects whether to distribute or download the digital contents file (S30). In the case of distributing the file, the user uploads the file to be distributed with a file name attached thereto (S40). In the case where the user intends to download a desired file (S30), he/she selects a desired file name by searching storage systems of other users through the main system 10 (S50). If the user selects the file name, the main system 10 classifies the file names incoherently inputted by the users into predetermined specified items, and judges whether the file name exists by comparing the classified items with the items of diverse digital contents files pre-stored in the digital contents list database 11. If the file name exists, the main system judges whether to distribute the file (S60). If the file selected by the user exists in the database 11 and its distribution is permitted, the user downloads the selected file (S70). When downloading the file, the dedicated program of the user system indicates that the file can be legally used in the method according to the present invention, and confirms whether a watermark for preventing the illegal use in another system exists in the file. If no watermark exists, the dedicated program watermarks the file (S80).

If the download of the file is completed, the settlement of account is performed through the settlement server (S90). If the settlement is completed, the account settlement server distributes settled amount to the rightful owner of the files and the user who has distributed the file (S100).

As can be seen from the foregoing, by applying the method according to the present invention, payment of the charges is made with respect to all the distributed digital contents holding the copyrights, and the user rather than the copyright holder voluntarily distributes the digital contents, resulting in that the sale of the digital contents is maximized without bearing the marketing expense or advertisement expense for the sale of the contents.

In addition, as specified charges are paid to the users who distribute the digital contents as the charges for distributing the digital contents, the users actively make their efforts to distribute the digital contents, resulting in that the distribution of the digital contents and the profits of the rightful owner of the digital contents can be maximized.

In addition, as the dedicated program having the watermarking function is used in the users' systems, the illegal copy and distribution of the digital contents and the rightful owner's loss resulted from the illegal copy and distribution can be prevented.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

What is claimed is:

1. A method for distributing and clearing digital contents via on-line which is performed by a system for distributing and clearing digital contents via on-line that includes Internet, systems of users who are consumers and distributors of digital contents through the Internet and a main system having a database for storing a list of the digital contents, the method comprising:
(a) the user system downloading and installing a dedicated program having a function of watermarking the digital contents and a function of executing the watermarked digital contents;
(b) the user system searching the systems of other users if the user system intends to purchase or download the digital contents; and
(c) the dedicated program installed in the user system performing watermarking of the downloaded digital contents when the digital contents are downloaded to the user system.

2. The method as claimed in claim 1, wherein in step (c), the dedicated program confirms whether the downloaded digital contents are watermarked by the dedicated program, and if the digital contents are not watermarked, it watermarks the downloaded digital contents, so that the watermarked digital contents are prevented from being executed in systems except for the system for distributing and clearing digital contents via on-line to prevent an illegal copy and use of the digital contents.

3. The method as claimed in claim 1, wherein in step (b), the user system searches the systems of other users through the main system.

4. The method as claimed in claim 3, further comprising (d) the user system providing information about the digital contents stored in the user system to the main system so that the main system stores the information about the digital contents in the database when the user system distributes or sells the digital contents.

5. The method as claimed in claim 4, further comprising (e) the main system downloading the digital contents that coincide with items pre-stored in the digital contents list database to the user system as the information about the digital contents selected to be purchased or downloaded by the user is transmitted from the user system to the main system.

6. The method as claimed in claim 4, wherein in step (d), the main system filters the file name of the digital contents by specified items and writes the filtered file name of the digital contents in the database when the main system writes the information about the digital contents in the database; wherein if the digital contents refer to music, the specified items include one or more of the title of music, a singer, a composer, a songwriter and a production agency, while if the digital contents refer to movie, the specified items include one or more of the title of a movie, a leading actor (or actress) and a production agency.

7. The method as claimed in claim 1, further comprising:
(f) settling charges for the digital contents through a settlement system according to a purchase of the digital contents; and
(g) an account settlement server distributing the settled amount between a rightful owner of the digital contents and a user who has distributed the digital contents in a predetermined ratio.

8. A computer-readable recording medium recorded with a program having a function of compulsorily watermarking digital contents transmitted from a computer of another user through P2P; and
a function of executing the watermarked digital contents.

9. The computer-readable recording medium as claimed in claim 8, wherein the program further includes:
a function of confirming whether the downloaded digital contents have been watermarked by the program; and
a function of watermarking the downloaded digital contents if the digital contents have not been watermarked.
